(19) United States
(12) Patent Application Publication
(10) Pub. No.: US 2018/0093191 A1
(43) Pub. Date: Apr. 5, 2018

(54) APPARATUS FOR GENERATING GAME MANAGEMENT SCENARIO AND METHOD USING THE SAME

(71) Applicant: Electronics and Telecommunications Research Institute, Daejeon (KR)

(72) Inventor: Sang Kwang LEE, Daejeon (KR)

(73) Assignee: Electronics and Telecommunications Research Institute, Daejeon (KR)

(21) Appl. No.: 15/720,138

(22) Filed: Sep. 29, 2017

(30) Foreign Application Priority Data
Sep. 30, 2016 (KR) 10-2016-0126460

(51) Int. Cl. A63F 13/798; A63F 13/77; A63F 13/67; A63F 13/69

(52) U.S. Cl. CPC A63F 13/798; A63F 13/69; A63F 13/67; A63F 13/77

(57) ABSTRACT

Provided is an apparatus for generating a game scenario including a management scenario matching unit, a management feature extracting unit, a behavior feature extracting unit, a feature merging unit, a merged behavior predicting unit, a relation analyzing unit, and a management element setting unit.

### CROSS-REFERENCE TO RELATED APPLICATION

This application claims priority to and the benefit of Korean Patent Application No. 10-2016-0126460, filed on Sep. 30, 2016, the disclosure of which is incorporated herein by reference in its entirety.

### BACKGROUND

### 1. Field of the Invention

The present invention relates to an apparatus for generating a game management scenario and a method using the same, and more particularly, to an apparatus for predicting a behavior of a gamer and generating a game management scenario on the basis of the predicted behavior, and a method using the same.

### 2. Discussion of Related Art

A gamer behavior predictive modeling for designing a game management scenario according to conventional technologies suggests a predictive modeling related to a game churn of a gamer or suggests a behavior predictive modeling related to a game churn, a first purchase and the like.

The conventional technologies are limited only to a gamer behavior predictive modeling, without suggesting a method of generating a management scenario applicable to an actual game management service.

Korean Laid-Open Patent Publication No. 10-2005-0096791 discloses a technology relating to a gamer's game style transplanting system and its processing method by artificial intelligence learning, in which a game style, such as a gamer's way of conducting a game or a gamer's habit, is learned, and the learned game style is applied to a game to provide a variety of game characters.

However, such an analysis of a gamer's game style is not applicable to generating a general-purpose game management scenario for a game management.

### SUMMARY OF THE INVENTION

The present invention is directed to providing a management scenario generation system which is optimized to be applicable to an actual game service by analyzing a correlation between a prediction object behavior and a management scenario after modeling a gamer's behavior.

The technical objectives of the present invention are not limited to the above disclosure, and other objectives may become apparent to those of ordinary skill in the art based on the following descriptions.

According to one aspect of the present invention, there is provided an apparatus for generating a game scenario according to an aspect of the present invention includes: a management scenario matching unit configured to determine a management scenario according to a behavior of a gamer; a management feature extracting unit configured to extract a management feature value included in game log data of the gamer from a list of management features included in a management element of the determined management scenario; a behavior feature extracting unit configured to extract a behavior feature value included in the game log data from a behavior feature list; a feature merging unit configured to generate a merged behavior feature value by merging the extracted management feature value with the extracted behavior feature value; a merged behavior predicting unit configured to perform a predictive modeling through a supervised learning according to a label which records a result obtained by a behavior of the gamer using the merged behavior feature value as an input; a relation analyzing unit configured to produce an importance of the management feature by calculating a correlation between the merged behavior feature value and the extracted management feature value from the predictive model trained by the merged behavior predicting unit; and a management element setting unit configured to set a management element value using the importance of the management feature.

According to another aspect of the present invention, there is provided a method of generating a game scenario includes: a management scenario matching step of determining a management scenario according to a behavior of a gamer; a management feature and behavior feature extracting step of extracting a management feature value included in game log data of the gamer from a list of management features included in a management element of the determined management scenario, and extracting a behavior feature value included in the game log data from a behavior feature list; a management feature analyzing step of analyzing a management feature value which is not allowable to be analyzed for each gamer among the extracted management feature values; a feature merging step of generating a merged behavior feature value by associating the extracted management feature value with the extracted behavior feature value; a merged behavior predicting step of performing a predictive modeling through a supervised learning according to a label of the gamer using the merged behavior feature value as an input; a relation analyzing step of producing an importance of the management feature by calculating a correlation between the merged behavior feature values from the predictive model trained in the merged behavior prediction; and a management element setting step of setting a management element value using the analyzed management feature value.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a structural view illustrating an apparatus for generating a game scenario according to an embodiment of the present invention;

FIG. 2 is an exemplary view illustrating a management feature list according to an embodiment of the present invention;

FIG. 3 is an exemplary view illustrating a merged behavior feature value list according to an embodiment of the present invention;

FIG. 4 is a flowchart showing a method of generating a game scenario according to an embodiment of the present invention;

FIG. 5 is a flowchart showing a method of generating a game scenario according to another embodiment of the present invention;

FIG. 6 is a flowchart showing a method of generating a game scenario according to still another embodiment of the present invention; and

FIG. 7 is a structural view of a computer system for executing a method of generating a game scenario according to an embodiment of the present invention.

### DETAILED DESCRIPTION OF EXEMPLARY EMBODIMENTS

The above and other advantages, features, and a scheme for the advantages of the present invention will become readily apparent with reference to the following detailed description when considered in conjunction with the accompanying drawings. However, the scope of the present invention is not limited to such embodiments, and the present invention may be realized in various forms. The embodiments to be described below are nothing but embodiments provided to complete the disclosure of the present invention and assist those skilled in the art to completely understand the present invention. The present invention is defined only by the scope of the appended claims. Meanwhile, the terms used herein are used to aid in the explanation and understanding of the present invention and are not intended to limit the scope spirit of the present invention. It should be understood that the singular forms “a,” “an,” and “the” include the plural forms unless the context clearly dictates otherwise. The terms “comprises,” “comprising,” “includes,” and/or “including,” when used herein, specify the presence of stated features, integers, steps, operations, elements, components and/or groups thereof, and do not preclude the presence or addition of one or more other features, integers, steps, operations, elements, components, and/or groups thereof.

Hereinafter, an exemplary embodiment of the present invention will be described in detail with reference to the accompanying drawings.

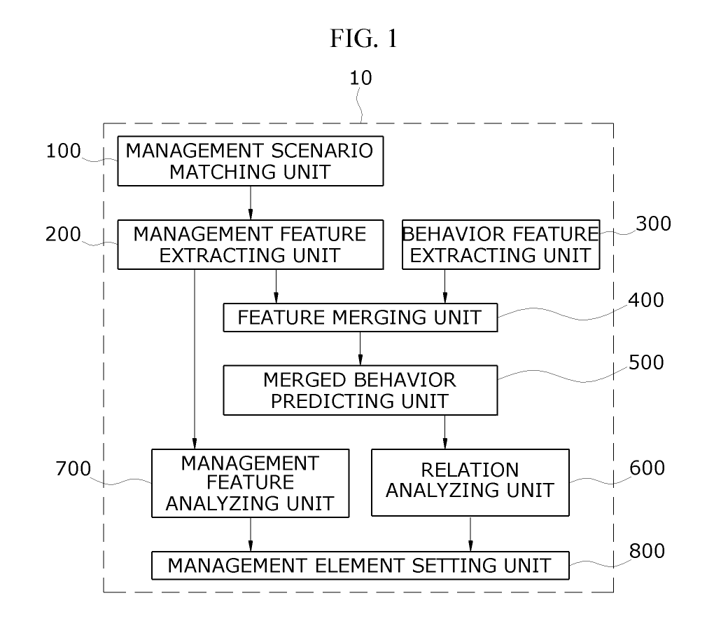

FIG. 1 is a structural view illustrating an apparatus 10 for generating a game management scenario according to an embodiment of the present invention.

The apparatus 10 for generating a game management scenario includes a management scenario matching unit 100, a management feature extracting unit 200, a behavior feature extracting unit 300, a feature merging unit 400, a merged behavior predicting unit 500, a relation analyzing unit 600, a management feature analyzing unit 700, and a management element setting unit 800.

The management scenario matching unit 100 determines a type of a management scenario according to a behavior of a gamer, that is, a prediction object.

The behavior of the gamer includes a game churn, a first purchase, and the like, and the management scenario includes an attendance event, a beginner purchase discount event, and the like occurring during a game.

Determining a management scenario according to a gamer's behavior is achieved by using a table in which a gamer's behavior matches a management scenario. For example, a matching table for matching a game churn and an attendance event and a matching table for matching a first purchase and a beginner purchase discount event are preset to be used to determine a scenario.

The management scenario matching unit 100 analyzes a process of a gamer conducting a game in the game and determines a management scenario preset according to the gamer's behavior to suit the result of the analysis among various types of scenarios.

The management scenario matching unit 100 sends the management feature extracting unit 200 a management feature list included in management elements of the determined management scenario.

The management elements refer to items constituting a management scenario. For the above-described attendance event scenario, a management element may include an attendance event period, a type of compensation by dates, an amount of compensation by dates, and the like.

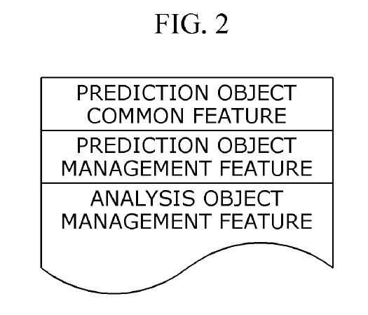

FIG. 2 is an exemplary view illustrating a management feature list according to an embodiment of the present invention.

A management feature list includes a prediction object common feature included in behavior feature lists of a plurality of gamers in common, a prediction object management feature excluded in a behavior feature list, and an analysis object management feature which may not be analyzed by the merged behavior predicting unit 500.

A behavior feature refers to features that indicate a behavior of a gamer. For a game churn as a gamer's behavior, the behavior feature may include an unconnected period of a gamer, a total game play time, and the like.

The behavior feature list may be generated by analyzing a behavior of a gamer based on game log data.

The management feature extracting unit 200 extracts a management feature value from the management feature list transmitted from the management scenario matching unit 100, on the basis of the game log data in which a gamer's game execution process is stored.

The management feature extracting unit 200 sends the feature merging unit 400 a management feature value which may be analyzed by the merged behavior predicting unit 500 among the extracted management feature values, and sends the management feature analyzing unit 700 a management feature value which may not be analyzed by the merged behavior predicting unit 500.

The merged behavior predicting unit 500 predicts a behavior of each gamer. Since a management feature, such as the number of connected users by dates, the total amount of cash items purchased in a game, and the like, is not a management feature to be obtained for each gamer, these management features are not transmitted to the merged behavior predicting unit 500 but to the management feature analyzing unit 700.

The behavior feature extracting unit 300 extracts a behavior feature value in the behavior feature list from the game log data and transmits the extracted behavior feature value to the feature merging unit 400.

The feature merging unit 400 generates a merged behavior feature value by merging the management feature value received from the management feature extracting unit 200 with the behavior feature value received from the behavior feature extracting unit 300, and transmits the generated merged behavior feature value to the merged behavior predicting unit 500.

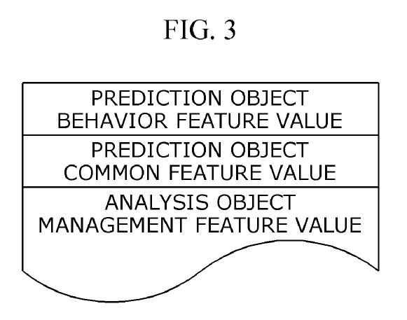

FIG. 3 is an exemplary view illustrating a merged behavior feature value list according to an embodiment of the present invention.

A merged behavior feature value includes a prediction object behavior feature value included only in the behavior feature list, a prediction object common feature value included in the behavior feature list and the management feature list in common, and a prediction object management feature value included only in the management feature list.

The merged behavior predicting unit 500 receives the merged behavior feature value and performs a predictive modeling through a supervised learning according to a label of a prediction object.

A label of a prediction object is a type of an indication related to a behavior of each gamer, wherein, in the case of a behavior of a game churn, a number 1 or 0 for each gamer indicates whether a behavior of a game churn has been executed.

Since the right answer to an inquiry whether the behavior has been executed is identified for each gamer by the label, the merged behavior predicting unit 500 models a behavior prediction through a supervised learning of performing a machine learning in a state that the right answer is identified with the merged behavior feature value serving as an input.

The supervised learning may be provided using various machine learning methods, for example, decision tree learning, random forest and the like.

The relation analyzing unit 600 produces an importance of the management feature by calculating a correlation between the merged behavior feature value from the predictive model trained by the merged behavior predicting unit 500 and the management feature value, and transmits the calculated importance to the management element setting unit 800.

The importance of the merged behavior feature value is calculated by the merged behavior predicting unit 500 through decision tree learning or random forest, and the correlation between the behavior feature value and the management feature value is obtained through a Pearson correlation coefficient.

By using the importance of the merged behavior feature value and the Pearson correlation coefficient between the behavior feature value and the management feature value obtained as described above, the importance of the management feature value is estimated finally.

The management feature analyzing unit 700 analyzes a management feature value, which may not be analyzed by the merged behavior predicting unit 500, in the management feature list.

The management feature analyzing unit 700 analyzes a management feature which may not be analyzed by the merged behavior predicting unit 500, for example, a feature, such as the number of connected users by dates, are analyzed by statistical value calculation of log data, and other management features are analyzed according to the properties of the respective management features by optimal analysis methods.

The management element setting unit 800 sets a management element value using information related to the importance of the management feature value transmitted from the relation analyzing unit 600 and a result of the analysis of the management feature value transmitted from the management feature analyzing unit 700, thereby generating a management scenario.

For example, when a cash item holding feature is analyzed as having a high importance among management features, a type of compensation is determined to a cash item, and an amount of compensation for cash items is determined according to a value of the importance.

As each management element is determined as described above, a management scenario including management elements is completed.

As described above, a behavior of a gamer is analyzed such that a subsequent behavior of the gamer is predicted, and a management scenario is generated to correspond to the predicted behavior, so that the management scenario optimal to the gamer is generated.

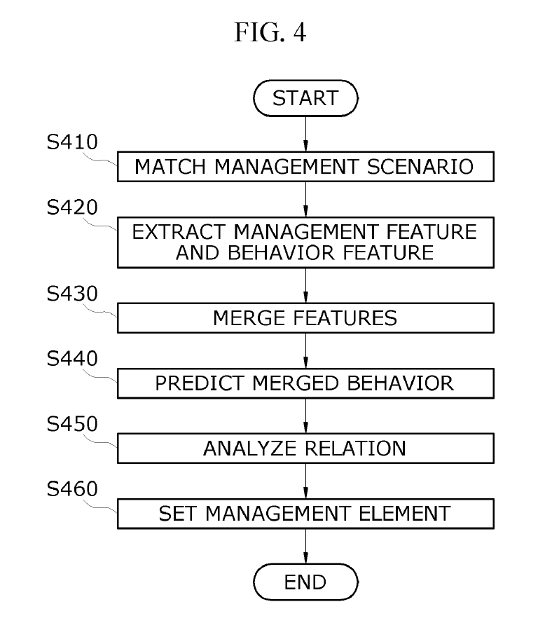

FIG. 4 is a flowchart showing a method of generating a game management scenario according to an embodiment of the present invention.

In a management scenario matching operation, a type of a management scenario is determined according to a behavior of a gamer, that is, a prediction object (S410).

After the type of a management scenario is determined, in a management feature and behavior feature extracting operation, a management feature value included in game log data of the gamer is extracted from a management feature list included in management elements of the management scenario, and a behavior feature value included in a behavior feature list is extracted from the game log data (S420).

In a feature merging operation, the management feature value and behavior feature value extracted as the above are merged to generate a merged behavior feature value (S430).

In a merged behavior predicting operation, a predictive modeling is performed through a supervised learning according to a label of the prediction object gamer using the generated merged behavior feature value (S440).

In a relation analyzing operation, a correlation between the merged behavior feature value calculated from the trained predictive model and the management feature value is calculated so that the importance of the management feature value is produced (S450).

Finally, in a management element setting operation, a management element value is set according to the importance of the management feature value produced in the relation analyzing operation, thereby generating a management scenario (S460).

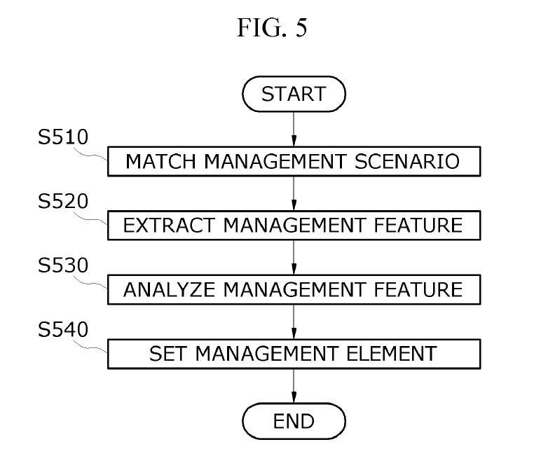

FIG. 5 is a flowchart showing a method of generating a game scenario according to another embodiment of the present invention.

In a management scenario matching operation, a type of a management scenario is determined according to a behavior of a gamer, that is, a prediction object (S510).

In a management feature extracting operation, a management feature value in a management list of the determined management scenario on the basis of game log data is extracted (S520).

In a management element analyzing operation, an analysis of the management feature value is performed (S530).

In a management element setting operation, a management element value is set using a result of analyzing the management feature value, so that a management scenario is generated.

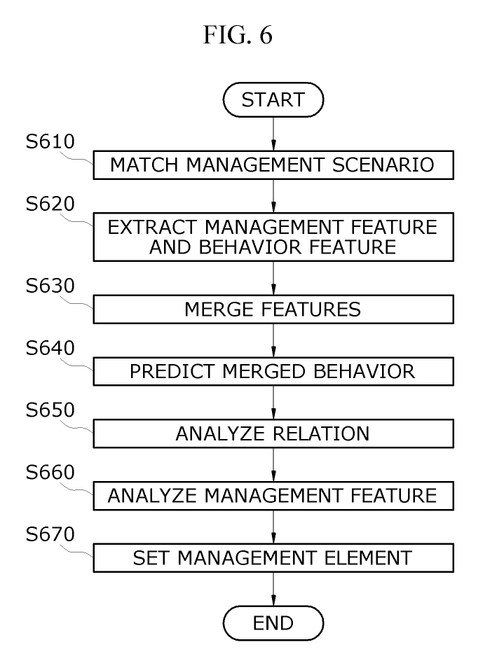

FIG. 6 is a flowchart showing a method of generating a game scenario according to still another embodiment of the present invention.

In a management scenario matching operation, a type of a management scenario is determined according to a behavior of a gamer, that is, a prediction object (S610).

After the type of a management scenario is determined, in a management feature and behavior feature extracting operation, a management feature value included in game log data of the gamer is extracted from a management feature list included in management elements of the management scenario, and a behavior feature value included in a behavior feature list is extracted from the game log data (S620).

In a feature merging step, the management feature value and behavior feature value extracted as the above are merged to generate a merged behavior feature value (S630).

In a merged behavior predicting step, a predictive modeling is performed through a supervised learning according to a label of the prediction object gamer using the generated merged behavior feature value (S640).

In a relation analyzing step, a correlation between the merged behavior feature value calculated from the trained predictive model and the management feature value is calculated so that the importance of the management feature value is produced (S650).

In a management feature analyzing step, a management feature value not predictable in the merged behavior predicting operation, among management feature values extracted in the management feature and behavior feature extracting step is analyzed (S660).

Finally, in a management element setting step, a management element value is set using information about the importance of the management feature produced in the relation analyzing operation and a result of the management feature value analyzed in the management feature analyzing step, thereby completing generation of a management scenario (S670).

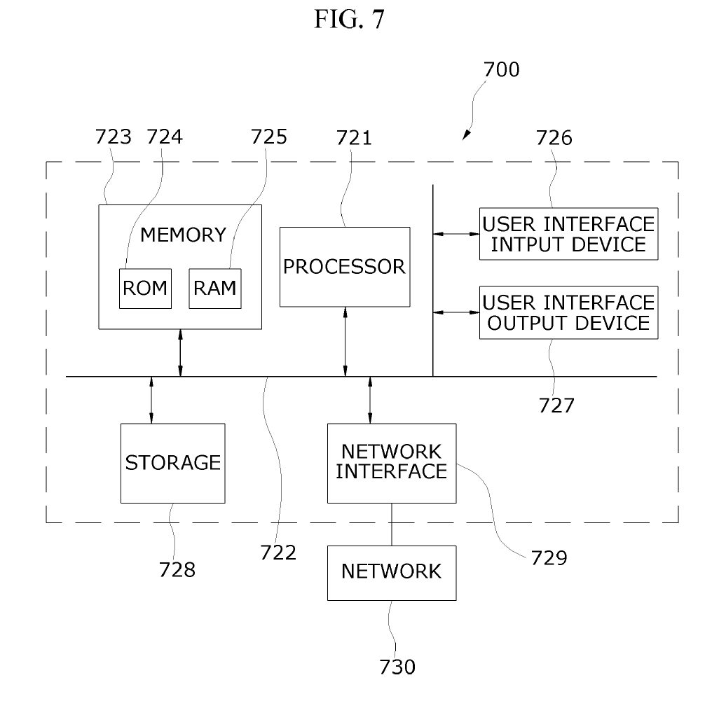

Meanwhile, the method of generating a game management scenario according to the embodiments of the present invention may be implemented in a computer system, or may be recorded in a recording medium. As shown in FIG. 7, a computer system may include at least one processor 721, a memory 723, a user input device 726, a data communication bus 722, a user output device 727, and a storage device 728. The components described above perform a data communication through the data communication bus 722 between each other.

The computer system may further include a network interface 729 coupled to a network. The processor 721 may be a central processing unit (CPU), or a semiconductor device which processes instructions stored in the memory 723 and/or the storage device 728.

The memory 723 and the storage device 728 may include various types of volatile or non-volatile storage media. For example, the memory 723 may include a read-only memory (ROM) 724 and a random access memory (RAM) 725.

Accordingly, the method of generating a game management scenario according to the embodiments of the present invention may be implemented in a way to be executed in a computer. The recognition method according to the present invention may be performed using computer readable instructions when the method of generating a game management scenario according to the embodiments of the present invention is executed in a computer apparatus.

Meanwhile, the method of generating a game management scenario according to the present invention described above may be implemented as a computer-readable code on a computer-readable recording medium. The computer-readable recording medium includes all types of recording media in which data readable by a computer system is stored, for example, a ROM, a RAM, a magnetic tape, a magnetic disk, a flash memory, an optical data. storage device, and the like, in addition, the computer-readable recording medium may be stored and executed in the form of codes that are distributed over computer systems connected via a computer communication network to be readable in a distributed manner.

As is apparent from the above, a management scenario, which has not been attempted, is automatically generated after a prediction of a gamer's behavior and is applied to a game service, so that a game manger can be provided with a convenience and a game service company can improve profitability.

Although exemplary embodiments of the present invention have been described for illustrative purposes, those skilled in the art should appreciate that various modifications, additions and substitutions are possible without departing from the scope and spirit of the disclosure. Therefore, exemplary embodiments of the present invention have not been described for limiting purposes but for illustrative purposes. Accordingly, the scope of the disclosure is not to be limited by the above embodiments but to be defined by the claims and the equivalents thereof.

What is claimed is:

1. An apparatus for generating a game scenario having one or more processors, the apparatus comprising:
a management scenario matching unit configured to determine a management scenario according to a behavior of a gamer;
a management feature extracting unit configured to extract a management feature value included in game log data of the gamer from a list of management features included in a management element of the determined management scenario;
a behavior feature extracting unit configured to extract a behavior feature value included in the game log data from a behavior feature list;
a feature merging unit configured to generate a merged behavior feature value by merging the extracted management feature value with the extracted behavior feature value;
a merged behavior predicting unit configured to perform a predictive modeling through a supervised learning according to a label which records a result obtained by a behavior of the gamer using the merged behavior feature value as an input;
a relation analyzing unit configured to produce an importance of the management feature by calculating a correlation between the merged behavior feature value and the extracted management feature value from the predictive model trained by the merged behavior predicting unit; and
a management element setting unit configured to set a management element value using the importance of the management feature.

2. The apparatus of claim 1, further comprising a management feature analyzing unit configured to analyze a management feature value which is not allowable to be analyzed by the merged behavior predicting unit among the management feature values extracted by the management feature extracting unit.

3. The apparatus of claim 1, wherein the list of management features includes:
a prediction object common feature included in behavior feature lists of a plurality of gamers in common;
a prediction object management feature excluded in the behavior feature list; and
an analysis object feature which is not allowable to be analyzed by the merged behavior predicting unit.

4. The apparatus of claim 1, wherein a list of the merged behavior feature values includes:
a prediction object behavior feature value included only in the behavior feature list;
a prediction object common feature value included in the behavior feature list and the list of management features in common; and
a prediction object management feature value included only in the list of management features.

5. A method of generating a game scenario performed by one or more processors, the method comprising:
a management scenario matching step of determining a management scenario according to a behavior of a gamer;
a management feature and behavior feature extracting step of extracting a management feature value included in game log data of the gamer from a list of management features included in a management element of the determined management scenario, and extracting a behavior feature value included in the game log data from a behavior feature list;
a feature merging step of generating a merged behavior feature value by merging the extracted management feature value with the extracted behavior feature value;
a merged behavior predicting step of performing a predictive modeling through a supervised learning according to a label which records a result obtained by a behavior of the gamer using the merged behavior feature value as an input;
a relation analyzing step of producing an importance of the management feature by calculating a correlation between the merged behavior feature value and the extracted management feature value from the predictive model trained in the merged behavior prediction; and
a management element setting step of setting a management element value using the importance of the management feature.

6. The method of claim 5, wherein the list of management features includes:
a prediction object common feature included in behavior feature lists of a plurality of gamers in common;
a prediction object management feature excluded in the behavior feature list; and
an analysis object feature which is not allowable to be analyzed in the merged behavior prediction.

7. The method of claim 5, wherein a list of the merged behavior feature values includes:
a prediction object behavior feature value included only in the behavior feature list;
a prediction object common feature value included in the behavior feature list and the list of management features in common; and
a prediction object management feature value included only in the list of management features.

8. A method of generating a game scenario performed by one or more processors, the method comprising:
a management scenario matching step of determining a management scenario according to a behavior of a gamer;
a management feature and behavior feature extracting step of extracting a management feature value included in game log data of the gamer from a list of management features included in a management element of the determined management scenario, and extracting a behavior feature value included in the game log data from a behavior feature list;
a management feature analyzing step of analyzing a management feature value which is not allowable to be analyzed for each gamer among the extracted management feature values;
a feature merging step of generating a merged behavior feature value by associating the extracted management feature value with the extracted behavior feature value;
a merged behavior predicting step of performing a predictive modeling through a supervised learning according to a label the gamer using the merged behavior feature value as an input;
a relation analyzing step of producing an importance of the management feature by calculating a correlation between the merged behavior feature values from the predictive model trained in the merged behavior prediction; and
a management element setting step of setting a management element value using the analyzed management feature value.

9. The method of claim 8, wherein the list of management features includes:
a prediction object common feature included in behavior feature lists of a plurality of gamers in common;
a prediction object management feature excluded in the behavior feature list; and
an analysis object feature which is not allowable to be analyzed in the merged behavior prediction.

10. The method of claim 8, wherein a list of the merged behavior feature values includes:
a prediction object behavior feature value included only in the behavior feature list;
a prediction object common feature value included in the behavior feature list and the list of management features in common; and
a prediction object management feature value included only in the list of management features.
